(19) United States
(12) Patent Application Publication
(10) Pub. No.: US 2011/0248940 A1
(43) Pub. Date: Oct. 13, 2011

(54) TOUCH DISPLAY STRUCTURE AND TOUCH DISPLAY APPARATUS COMPRISING THE SAME

(75) Inventors: Kai-Cheng Chuang, Hsinchu (TW); Tzu-Ming Wang, Hsinchu (TW); Po-Wen Hsiao, Hsinchu (TW); Gwo-Feng Hwang, Hsinchu (TW)

(73) Assignee: E INK HOLDINGS INC., Hsinchu (TW)

(21) Appl. No.: 13/042,175

(22) Filed: Mar. 7, 2011

(30) Foreign Application Priority Data
Apr. 7, 2010 (TW) 099110714

(51) Int. Cl. G06F 3/041

(52) U.S. Cl. 345/173

(57) ABSTRACT

A touch display apparatus comprises a touch display structure and a touch controller electrically connected thereto. The touch display structure comprises a display layer, an electric circuit layer, and a second electrode. The electric circuit layer, disposed under the display layer, comprises a substrate, a driving electrode, and a first electrode. The driving electrode and the first electrode are disposed on an upper surface and a lower surface of the substrate, respectively, and are electrically connected to the touch controller, respectively. The second electrode is disposed under the first electrode and electrically connects to the touch controller. The first electrode and the second electrode generate a touch control signal in response to a press of a user or an electromagnetic signal. The touch controller receives and processes the touch control signal, and then, the touch controller transmits the touch control signal to the driving electrode to drive the display layer.

### CROSS-REFERENCES TO RELATED APPLICATIONS

This non-provisional application claims priority under 35 U.S.C. §119(a) on Taiwan Patent Application No. 099110714 filed on Apr. 7, 2010, which is hereby incorporated by reference in its entirety.

### BACKGROUND OF THE INVENTION

1. Field of the Invention

The present invention relates to a touch display structure and a touch display apparatus comprising the touch display structure. In particular, the present invention relates to a touch display structure in which a driving electrode and an upper touch electrode are disposed on a same electric circuit substrate and a touch display apparatus comprising the same. Furthermore, the present invention relates to a touch display structure in which a driving electrode and a first antenna layer electrode of the upper touch electrode are disposed on the same electric circuit substrate and a touch display apparatus comprising the same.

2. Descriptions of the Related Art

With the rapid development of touch display technologies, touch display panel products have found a wide application in various electronic products due to its advantages, such as simple integration, low power consumption, light weight, good portability and low cost. Moreover, with the rapid development in flat or flexible display panel products, touch panels have increasingly been integrated with the flat or flexible display panels to make such products more convenient and meet consumer demands. Therefore, such products have become a primary target of research and development in the art in the recent years.

FIG. 1 illustrates an exploded cross-sectional view of a conventional touch display structure 1. The conventional touch display structure 1 comprises a touch portion 11 and a display portion 13. The touch portion 11 has two substrates 111, touch electrodes 113 and spacers 115 sandwiched therebetween. The display portion 13 has a display layer 131, touch electrodes 133, thin film transistors (TFTs) 135 and a substrate 137.

As shown in FIG. 1, the conventional touch display structure 1 has a touch portion 11 directly attached onto the display surface 130 of the display layer 131 so that the user can straightforwardly touch the touch electrodes 133. However, because the substrate 111 in the touch portion 11 is made of a transparent glass material, the cost thereof is relatively high. Moreover, because the touch portion 11 has to be disposed on the display surface 130 of the display portion 13, the visible luminance of the touch display structure 1 is reduced, which may lead to the visual fatigue of the user. Additionally, the touch portion 11 comprises two substrates 111, which not only occupy a certain thickness but also limit the development of the touch display structure towards a more lightweight and thin profile.

The above discussion of the conventional touch display structure refers the use of a resistive touch display structure. However, the limitations of the resistive touch display structure are not unique; electromagnetic touch display structures currently available also suffer from similar problems, i.e., high costs and limitations in the development towards a more lightweight and thin profile.

Accordingly, it is important to provide a touch display structure which has a lighter and thinner volume, higher visible luminance and lower cost than that of the prior art, and a touch display apparatus comprising such touch display structure.

### SUMMARY OF THE INVENTION

To solve the aforesaid problems, an objective of the present invention is to provide a touch display structure of a touch display apparatus that has a lighter and thinner volume, decreased cost and non-degraded display luminance.

To achieve the aforesaid objective, the present invention provides a touch display structure for a touch display apparatus. The touch display apparatus further has a touch controller electrically connected to the touch display structure. The touch display structure comprises a display layer, an electric circuit layer and a lower touch electrode. The electric circuit layer is disposed under the display layer and comprises a substrate, a driving electrode and an upper touch electrode. The driving electrode and the upper touch electrode are disposed on an upper surface and a lower surface of the substrate respectively and are electrically connected to the touch controller respectively. The lower touch electrode is disposed on an upper surface of a touch electrode substrate and is electrically connected to the touch controller. The upper touch electrode and the lower touch electrode generate a touch signal in response to a press of a user. The touch signal is then received, processed by the touch controller and then transmitted to the driving electrode to drive the display layer.

Another objective of the present invention is to provide a touch display apparatus comprising a touch controller and a touch display structure described above. The touch controller is electrically connected to the touch display structure so that according to a touch signal generated by the touch display structure in response to a press of a user, the touch controller drives the touch display structure into operation.

The present invention further provides a touch display structure and a touch display apparatus comprising the same. Similar to the touch display structure and the touch display apparatus described above, the touch display apparatus has a touch controller electrically connected to the touch display structure. The touch display structure comprises a display layer, an electric circuit layer, a second antenna layer electrode and a touch electrode substrate. The electric circuit layer is disposed under the display layer and comprises a substrate, a driving electrode and a first antenna layer electrode. The driving electrode and the first antenna layer electrode are disposed on an upper surface and a lower surface of the substrate respectively and are electrically connected to the touch controller respectively. The second antenna layer electrode is disposed on an upper surface of a touch electrode substrate and is electrically connected to the touch controller. The first antenna layer electrode and the second antenna layer electrode form a magnetic field receiving surface. In response to an electromagnetic signal, an energy distribution of the magnetic field receiving surface is altered to generate a touch signal. The touch signal is then received, processed by the touch controller and then transmitted to the driving electrode to drive the display layer.

Yet a further objective of the present invention is to provide a touch display apparatus comprising a touch controller and a touch display structure described above. The touch controller is electrically connected to the touch display structure so that in response to an electromagnetic signal, an energy distribution is altered by the touch display structure to generate a touch signal. The touch signal is then received, processed by the touch controller and then transmitted to the driving electrode to drive the display layer.

Accordingly, with the aforesaid arrangement, the present invention no longer needs to dispose the touch display structure on the display surface, which makes it unnecessary to use an expensive transparent material as the substrate of the touch display structure. In addition, the luminance is not degraded because the sensing assembly no longer shelters the display surface. Furthermore, by disposing the driving electrode and the upper touch electrode on the same electric circuit substrate, the present invention reduces the use of materials, thereby, shrinking the overall volume and reducing manufacturing costs. Thus, the problems of the prior art can be effectively solved by the present invention.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is an exploded cross-sectional view of a conventional touch display structure;

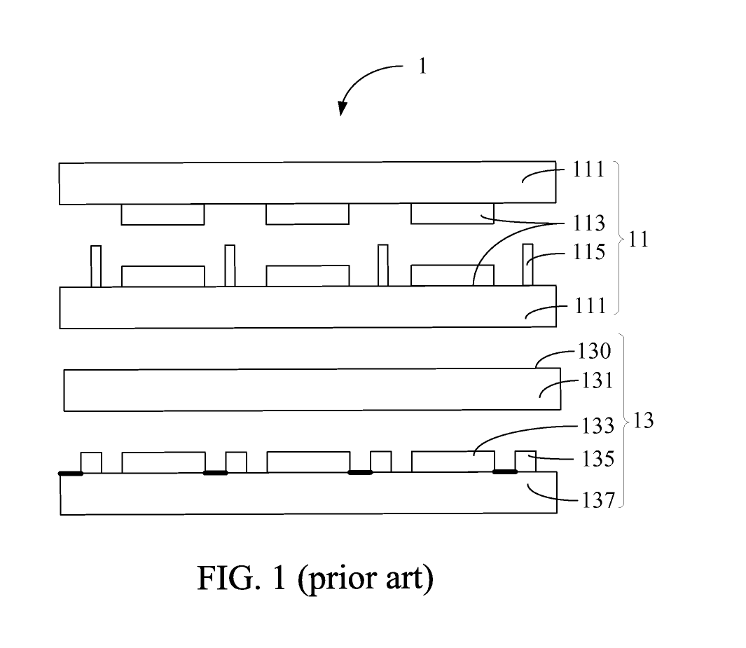

FIG. 2 is a schematic view of a touch display apparatus according to an embodiment of the present invention;

FIG. 3 is an exploded cross-sectional view of a touch display structure according to the embodiment of the present invention;

FIG. 4 is a schematic view of a touch display apparatus according to another embodiment of the present invention; and

FIG. 5 is an exploded cross-sectional view of a touch display structure according to another embodiment of the present invention.

### DESCRIPTION OF THE PREFERRED EMBODIMENT

In the following description, a touch display structure of the present invention will be explained with reference to embodiments thereof. It should be appreciated that these embodiments are not intended to limit the present invention to any specific environment, applications or particular implementations described in these embodiments. Therefore, the description of these embodiments is only for purposes of illustration rather than limitation.

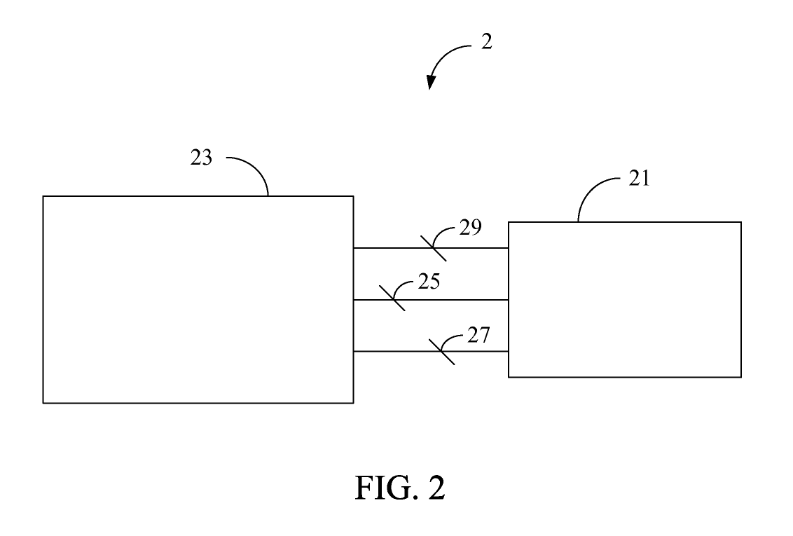

First, in reference to FIG. 2, which illustrates a schematic view of a touch display apparatus 2 according to an embodiment of the present invention, the touch display apparatus 2 comprises a touch controller 21, a touch display structure 23, a first lead 25, a second lead 27 and a third lead 29. In application, the touch display apparatus 2 can be an E-ink panel or a flexible flat panel display. The touch controller 21 is electrically connected to the touch display structure 23. A touch signal (not shown) transmitted by the touch display structure 23 is received through the first lead 25 and the second lead 27 and processed by the touch controller 21 to drive, through the third lead 29, the touch display structure 23 to perform the corresponding actions.

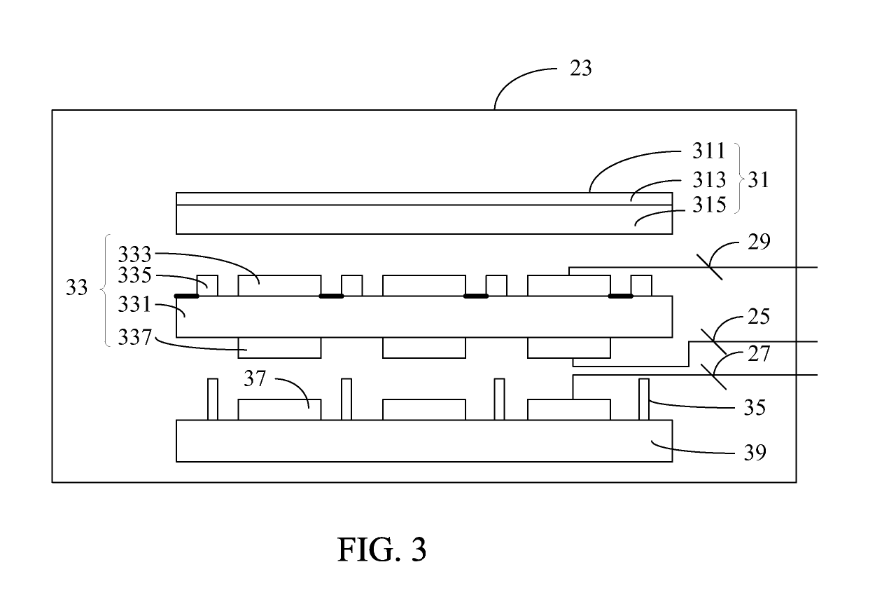

More specifically, with reference to FIG. 3, which shows an exploded cross-sectional view of the touch display structure 23, the touch display structure 23 comprises a display layer 31, an electric circuit layer 33, a plurality of spacers 35, a lower touch electrode 37 and a touch electrode substrate 39.

The display layer 31 comprises a transparent electrode 313, which has a display surface 311, and an electrophoretic material 315. The electric circuit layer 33, the lower touch electrode 37 and the touch electrode substrate 39 are disposed on a surface opposite the display surface 311. With the aforesaid arrangement, an image presented by the display surface 311 will be directly presented to the user without degrading the visible luminance because the electric circuit layer 33, the lower touch electrode 37 and the touch electrode substrate 39 are unable to block the image.

The electric circuit layer 33 is disposed under the display layer 31 and comprises a substrate 331, a plurality of driving electrodes 333, a plurality of thin film transistors (TFTs) 335 and an upper touch electrode 337. The driving electrodes 333 and the upper touch electrode 337 are disposed on an upper surface and a lower surface of the substrate 331 respectively and are electrically connected to the touch controller 21 respectively. The TFTs 335 are also disposed on the upper surface of the substrate 331 and are electrically connected to the driving electrodes 333 to control, through switching operations, the display of the display layer 31.

The lower touch electrode 37 is disposed under the upper touch electrode 337 and on an upper surface of the touch electrode substrate 39. The lower touch electrode 37 is electrically connected to the touch controller 21.

Both the substrate 331 and the touch electrode substrate 39 are printed circuit boards (PCB) that may be made of a material selected from the following: glass, flexible polyvinyl chloride, polyethylene terephthalate, polyimide, polyetheretherketone, polyethylene naphthalene-2, 6-dicarboxylate, or combinations thereof. The upper touch electrode 337 and the lower touch electrode 37 may be made of a material selected from the following: organic macromolecular polymers, metals (electrically conductive materials such as gold, copper, carbon, silver or tin), carbon nanotubes, graphite, carbon compounds, or combinations thereof. However, the materials described above are only provided as exemplary examples in this embodiment, and the present invention is not merely limited thereto.

The spacers 35 are disposed between the upper touch electrode 337 and the lower touch electrode 37 to electrically insulate the upper touch electrode 337 from the lower touch electrode 37. In detail, a plurality of spaces are defined between the upper touch electrode 337 and the lower touch electrode 37 by a plurality of spacers 35 to isolate and electrically insulate the upper touch electrode 337 from the lower touch electrode 37. In this embodiment, the spacers 35 may be made of an electrically non-conductive material such as polyvinyl chloride or photoresist. In other embodiments, the spacers 35 may also be made of other insulating materials, but is not merely limited to the examples described above.

When used, the upper touch electrode 337 and the lower touch electrode 37 generate a touch signal in response to a press of a user. The touch signal is then received, processed by the touch controller 21 and then transmitted to the driving electrodes 333 to drive the display layer 31 to display.

In this embodiment, the upper touch electrode 337 and the lower touch electrode 37 are electrically connected to the touch controller 21 through the first lead 25 and the second lead 27 respectively. The touch controller 21 provides a scanning voltage (not shown) to each of the upper touch electrode halves 337 through the respective first lead 25 sequentially. When the display surface 311 of the display layer 31 is touched by the user, the upper touch electrode 337 will deform (e.g., concave) towards the lower touch electrode 37 in response to the touch to make contact with the lower touch electrode 37 through the space defined by the spacers 35 to present an on-state. At this point, the scanning voltage can be transmitted from the upper touch electrode 337 to the lower touch electrode 37 to generate a touch signal. The touch signal is then transmitted back to the touch controller 21 through the second lead 27 so that the touch controller 21 can determine the touch position.

In this embodiment, the upper touch electrodes 337 of this embodiment are horizontally and independently disposed on the substrate 331 of the electric circuit layer 33, while the lower touch electrodes 37 are vertically and independently disposed on an upper surface of the touch electrode substrate 39. Therefore, when the display surface 311 is viewed from above, the upper touch electrodes 337 and the lower touch electrodes 37 will jointly form many intersections substantially similar to lattice points, so the touch controller 21 can easily determine the coordinates and position in which an on-state occurs (i.e., the touch position).

For example, when the touch controller 21 provides the scanning voltage to one of the upper touch electrodes 337 through the first lead 25, if the display surface 311 of the display layer 31 is touched by the user, the upper touch electrode 337 and the corresponding lower touch electrode 37 will make contact with each other to present the on-state. The scanning voltage can then be transformed by the lower touch electrode 37 into a touch signal, which is then transmitted back to the touch controller 21 through the second lead 27. Thus, the touch controller 21 detects that the press occurs at the overlapping portion between the upper touch electrode 337 and the lower touch electrode 37 and thus, determine the pressing position. According to the aforesaid principle, the overlapped portion between the upper touch electrode 337 and the lower touch electrode 37 will be enlarged when the pressing force is larger, so the magnitude of the pressing force can be determined therefrom and multi-touch operations can further be detected simultaneously.

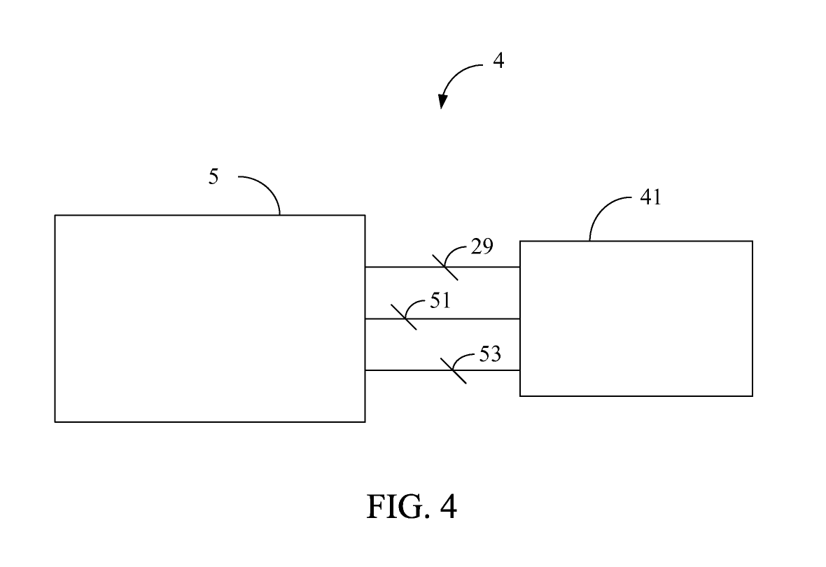

A schematic view of a touch display apparatus according to another embodiment of the present invention is as shown in FIG. 4. The touch display apparatus 4 has a structure generally similar to that of the touch display apparatus 2 of the aforesaid embodiment, so only differences of this embodiment from the aforesaid embodiment will be described hereinafter. In detail, the touch display apparatus 4 comprises a touch controller 41, a touch display structure 5, a third lead 29, a fourth lead 51 and a fifth lead 53. In application, the touch display apparatus 4 is an E-ink panel or a flexible flat panel display. The touch controller 41 is electrically connected to the touch display structure 5. A touch signal (not shown) transmitted by the touch display structure 5 is received through the fourth lead 51 and the fifth lead 53 and processed by the touch controller 41 to drive, through the third lead 29, the touch display structure 5 to perform the corresponding actions.

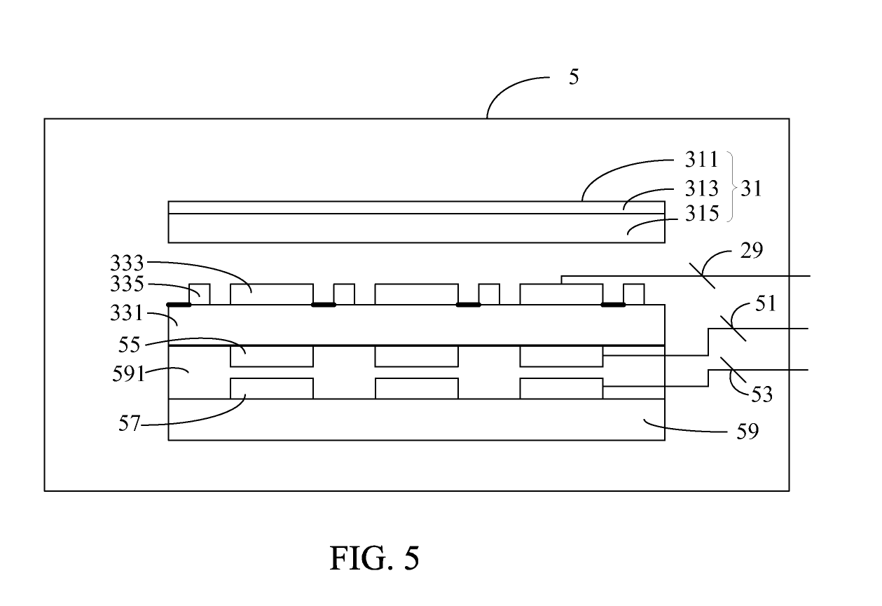

As shown in the cross-sectional view of FIG. 5, the touch display structure 5 comprises a display layer 31, an electric circuit layer 33, a first antenna layer electrode 55, a second antenna layer electrode 57, a touch electrode substrate 59 and an insulation layer 591. The first antenna layer electrode 55 is disposed on a lower surface of the substrate 331 of the electric circuit layer 33, while the second antenna layer electrode 57 is disposed on an upper surface of the touch electrode substrate 59. The first antenna layer electrode 55 and the second antenna layer electrode 57 are electrically connected to the touch controller 41 through the fourth lead 51 and the fifth lead 53 respectively. Furthermore, the insulation layer 591 is disposed on the upper surface of the touch electrode substrate 59 and is sandwiched between the first antenna layer electrode 55 and the second antenna layer electrode 57 to insulate the two electrodes from each other.

When used, the first antenna layer electrode 55 and the second antenna layer electrode 57 can form a magnetic field receiving surface as a signal receiving terminal. The user would need to use an electromagnetic pen (not shown) as a signal transmitting terminal to generate an electromagnetic signal. When the electromagnetic pen approaches the magnetic field receiving surface, the electromagnetic signal causes variations in the magnetic flux of the magnetic field receiving surface. Accordingly, the energy distribution of the magnetic field receiving surface is altered so that the first antenna layer electrode 55 and the second antenna layer electrode 57 come into contact to generate a touch signal. The touch signal can be transmitted to the touch controller 41 through the fourth lead 51 and the fifth lead 53. By receiving the computed energy distribution state, the touch controller 41 can define a position corresponding to the electromagnetic pen and control the driving electrodes 333 to drive the display layer 31 to display.

Accordingly, with the aforesaid arrangement, the present invention no longer needs to dispose the touch electrodes and the substrate on the display surface. This makes it unnecessary to use an expensive transparent material as the substrate of the touch display apparatus and prevents degradation of the luminance because the display is no longer sheltered by the substrates of the touch electrode. In addition, the thickness and the overall volume of the touch display apparatus are reduced, consequently, lowering manufacturing costs. Furthermore, because the substrates in the touch portion are eliminated, the touch sensing effect is enhanced. Thereby, the problems of the prior art can be effectively solved by the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A touch display structure for a touch display apparatus, wherein the touch display apparatus comprises a touch controller electrically connected to the touch display structure, the touch display structure comprising:
a display layer;
an electric circuit layer, being disposed under the display layer and comprising a substrate, a driving electrode and an upper touch electrode, wherein the driving electrode and the upper touch electrode are disposed on an upper surface and a lower surface of the substrate respectively and are electrically connected to the touch controller respectively; and
a lower touch electrode, being disposed under the upper touch electrode and electrically connected to the touch controller,
wherein the upper touch electrode and the lower touch electrode generate a touch signal in response to a press of a user, and the touch signal is received and processed by the touch controller and then transmitted to the driving electrode to drive the display layer.

2. The touch display structure as claimed in claim 1, further comprising a touch electrode substrate, wherein the lower touch electrode is disposed on an upper surface of the touch electrode substrate.

3. The touch display structure as claimed in claim 1, further comprising at least one spacer disposed between the upper touch electrode and the lower touch electrode.

4. The touch display structure as claimed in claim 1, wherein the electric circuit layer further comprises at least one thin film transistor (TFT) disposed on the upper surface of the substrate and electrically connected to the driving electrode.

5. The touch display structure as claimed in claim 1, wherein the substrate is a printed circuit board (PCB).

6. The touch display structure as claimed in claim 1, wherein the substrate is a glass plate or a polyimide (PI) sheet.

7. The touch display structure as claimed in claim 1, wherein the upper touch electrode and the lower touch electrode are made of a material selected from a group of: organic macromolecular polymers, metals, carbon nanotubes, graphite, carbon compounds, and combinations thereof.

8. The touch display structure as claimed in claim 1, wherein the display layer further comprises a transparent electrode and an electrophoretic material.

9. A touch display apparatus, comprising:
a touch controller;
a touch display structure electrically connected to the touch controller, the touch display structure comprising:
a display layer;
an electric circuit layer, being disposed under the display layer and comprising a substrate, a driving electrode and an upper touch electrode, wherein the driving electrode and the upper touch electrode are disposed on an upper surface and a lower surface of the substrate respectively and are electrically connected to the touch controller respectively; and
a lower touch electrode, being disposed under the upper touch electrode and electrically connected to the touch controller,
wherein the upper touch electrode and the lower touch electrode generate a touch signal in response to a press of a user, and the touch signal is received and processed by the touch controller and then transmitted to the driving electrode to drive the display layer.

10. The touch display apparatus as claimed in claim 9, wherein the touch display structure further comprises a touch electrode substrate, and the lower touch electrode is disposed on an upper surface of the touch electrode substrate.

11. The touch display apparatus as claimed in claim 9, wherein the touch display structure further comprises at least one spacer disposed between the upper touch electrode and the lower touch electrode.

12. The touch display apparatus as claimed in claim 9, wherein the electric circuit layer further comprises at least one TFT disposed on the upper surface of the substrate and electrically connected to the driving electrode.

13. The touch display apparatus as claimed in claim 9, wherein the substrate is a PCB.

14. The touch display apparatus as claimed in claim 9, wherein the substrate is a glass plate or a PI sheet.

15. The touch display apparatus as claimed in claim 9, wherein the upper touch electrode and the lower touch electrode are made of a material selected from a group of: organic macromolecular polymers, metals, carbon nanotubes, graphite, carbon compounds, and combinations thereof.

16. The touch display apparatus as claimed in claim 9, wherein the display layer further comprises a transparent electrode and an electrophoretic material.

17. The touch display apparatus as claimed in claim 9, wherein the touch display apparatus is an E-ink panel or a flexible flat panel display.

18. A touch display structure for use in a touch display apparatus, wherein the touch display apparatus comprises a touch controller electrically connected to the touch display structure, the touch display structure comprising:
a display layer;
an electric circuit layer, being disposed under the display layer and comprising a substrate, a driving electrode and a first antenna layer electrode, wherein the driving electrode and the first antenna layer electrode are disposed on an upper surface and a lower surface of the substrate respectively and are electrically connected to the touch controller respectively; and
a second antenna layer electrode, being disposed under the first antenna layer electrode and electrically connected to the touch controller, wherein the first antenna layer electrode and the second antenna layer electrode form a magnetic field receiving surface,
wherein, in response to an electromagnetic signal, an energy distribution of the magnetic field receiving surface is altered to generate a touch signal, and the touch signal is received and processed by the touch controller and then transmitted to the driving electrode to drive the display layer.

19. The touch display structure as claimed in claim 18, further comprising a touch electrode substrate, wherein the second antenna layer electrode is disposed on an upper surface of the touch electrode substrate.

20. The touch display structure as claimed in claim 18, further comprising an insulation layer disposed between the first antenna layer electrode and the second antenna layer electrode.

21. The touch display structure as claimed in claim 18, wherein the electric circuit layer further comprises at least one TFT disposed on the upper surface of the substrate and electrically connected to the driving electrode.

22. The touch display structure as claimed in claim 18, wherein the substrate is a PCB.

23. The touch display structure as claimed in claim 18, wherein the substrate is a glass plate or a PI sheet.

24. The touch display structure as claimed in claim 18, wherein the first antenna layer electrode and the antenna layer electrode are made of a material selected from a group of: organic macromolecular polymers, metals, carbon nanotubes, graphite, carbon compounds, and combinations thereof.

25. The touch display structure as claimed in claim 18, wherein the display layer further comprises a transparent electrode and an electrophoretic material.

26. The touch display structure as claimed in claim 18, wherein the electromagnetic signal is generated by an electromagnetic pen.

27. A touch display apparatus, comprising:
a touch controller;
a touch display structure electrically connected to the touch controller, the touch display structure comprising:
a display layer;
an electric circuit layer, being disposed under the display layer and comprising a substrate, a driving electrode and a first antenna layer electrode, wherein the driving electrode and the first antenna layer electrode are disposed on an upper surface and a lower surface of the substrate respectively and are electrically connected to the touch controller respectively; and
a second antenna layer electrode, being disposed under the first antenna layer electrode and electrically connected to the touch controller, wherein the first antenna layer electrode and the second antenna layer electrode form a magnetic field receiving surface,
wherein, in response to an electromagnetic signal, an energy distribution of the magnetic field receiving surface is altered to generate a touch signal, and the touch signal is received and processed by the touch controller and then transmitted to the driving electrode to drive the display layer.

28. The touch display apparatus as claimed in claim 27, wherein the touch display structure further comprises a touch electrode substrate, wherein the second antenna layer electrode is disposed on an upper surface of the touch electrode substrate.

29. The touch display apparatus as claimed in claim 27, wherein the touch display structure further comprises an insulation layer disposed between the first antenna layer electrode and the second antenna layer electrode.

30. The touch display apparatus as claimed in claim 27, wherein the electric circuit layer further comprises at least one TFT disposed on the upper surface of the substrate and electrically connected to the driving electrode.

31. The touch display apparatus as claimed in claim 27, wherein the substrate is a PCB.

32. The touch display apparatus as claimed in claim 27, wherein the substrate is a glass plate or a PI sheet.

33. The touch display apparatus as claimed in claim 27, wherein the first antenna layer electrode and the second antenna layer electrode are made of a material selected from a group of: organic macromolecular polymers, metals, carbon nanotubes, graphite, carbon compounds, and combinations thereof.

34. The touch display apparatus as claimed in claim 27, wherein the display layer further comprises a transparent electrode and an electrophoretic material.

35. The touch display apparatus as claimed in claim 27, wherein the touch display apparatus is an E-ink panel or a flexible flat panel display.

36. The touch display apparatus as claimed in claim 27, wherein the electromagnetic signal is generated by an electromagnetic pen.
